(19) United States
(12) Patent Application Publication
(10) Pub. No.: US 2012/0023022 A1
(43) Pub. Date: Jan. 26, 2012

(54) CARD-PRESENT SECURITY SYSTEM

(76) Inventors: Pat Carroll, Offaly (IE); John Petersen, London (GB); Jonathan Alford, Kent (GB)

(21) Appl. No.: 13/138,694

(22) PCT Filed: Mar. 22, 2010
(86) PCT No.: PCT/GB2010/000517

§ 371 Date: Oct. 13, 2011

(30) Foreign Application Priority Data
Mar. 20, 2009 (GB) 0904874.5
Sep. 11, 2009 (GB) 0916015.1

(51) Int. Cl. G06Q 20/32

(52) U.S. Cl. 705/44

(57) ABSTRACT

A method, system and apparatus for authenticating the validity of a transaction. The method includes the steps of receiving data identifying a means for carrying out the financial transaction; receiving data identifying a mobile network segment for routing communications via a mobile communication device associated with a user requesting the transaction; comparing the mobile network segment data and the data identifying the means for carrying out the transaction with a database of correlated data identifying one or more means for carrying out a transaction associated with further data identifying one or more mobile network segments; and authenticating the transaction in dependence on the result of the comparison.

### FIELD OF THE INVENTION

This invention relates to a card-present security system. The invention also relates to a method and system for authenticating a transaction as well as to a method and system for improving the quality of legitimacy checks on card-present financial transactions.

### BACKGROUND OF THE INVENTION

Card-present transactions are defined as those transactions where the card, either a debit or credit card, must be physically present at the point of the transaction, as distinct to card-not-present transactions, where only the details of the card are required. Card-present transactions therefore use Automatic Teller Machine (ATM), Point-of-Sale (PoS) terminals or other vending devices for transactions which require a physical card to be present.

Card-present fraud is a large and increasing problem worldwide, whether the result of lost, stolen or skimmed cards, where a copy of an original card is made which includes all necessary information contained within the skimmed card's magnetic strip. “Chip and Pin” technology was designed to counter card skimming, however, even in countries, such as the UK, where this is used, card-present fraud at ATMs and PoS terminals in the UK is increasing.

One potential method to counter card-present fraud is through the use of Location Based Services (LBS), traditionally based on Global Positioning Satellite (GPS) technology or Latitude Longitude calculations. The principle of these methods is based on measuring the distance of the cardholder's mobile telephone geo-location from the ATM or PoS terminal's geo-location to determine the legitimacy of the transaction. The problems with these methods, however, include slow response times in calculating the geo-location, relatively high cost, privacy issues related to monitoring a user's location, handset limitations requiring the use of GPS and the requirement for consistent and accurate address information of the ATM or PoS Terminal.

Therefore, the inventors have appreciated that it is desirable to have a system which reduces the number of fraudulent card present transactions, without using traditional location based services.

### SUMMARY OF THE INVENTION

The invention is defined in the appended claims to which reference should now be made. The inventors have appreciated that each Point of Sale terminal and each ATM have unique identifiers (ID's) associated with them. This data does not necessarily provide any information about the location of the PoS terminal or ATM but does serve to uniquely identify it.

Furthermore, mobile telephone companies may make available information relating to the mobile network segment with which a mobile telephone is currently registered. The mobile network segment allows communications to be routed to and from, in other words via, the mobile communication device associated with a user requesting a transaction.

Usually the mobile network segment information comprises a mobile switching centre (MSC) identifier. This does not provide location information relating to a mobile telephone or even the MSC itself, but instead provides a unique identifier relating to that MSC. Alternatively or additionally, it is also possible to use more specific information such as Location Area Identifiers, or/and Routing Area (RA) Identifiers or/and cell identifiers, otherwise known as Base Transceiver Station (BTS) identifiers if more granular or localised information is required.

Therefore, there is available unique ID information relating to an ATM or PoS terminal and unique information relating to the mobile network segment with which a mobile telephone is registered.

We have therefore appreciated that by correlation of mobile network segment data with data identifying a means for carrying out a financial transaction, particularly ATM or PoS terminal ID information, a database of information can be provided which associates each or selected ATM or PoS terminals with one or more particular mobile network segment identifiers. Therefore, when a user attempts to use an ATM or PoS terminal, a check can be made against the mobile network segment with which his mobile telephone is registered to determine a likelihood of the user associated with that mobile telephone being at that ATM or PoS. That is to say, if the correlation data indicates that a particular ATM or PoS terminal a user is attempting to use has a confirmed correlation with the mobile network segment identifier with which his mobile telephone is registered, then it is likely that the transaction he is attempting is legitimate.

This information may be provided directly to a financial institution such as a bank or may be provided by a third party at the request of a financial institution.

The correlation data may be established over a period of time and can be kept up-to-date by continuing to add to the correlation data as future transactions take place or as new ATMs and PoS terminals are introduced into the network. This ensures that any change in the mobile or ATM or PoS networks will be learnt by the correlation system and the system will continue to operate correctly.

According to one aspect of the present invention there is provided a method for determining the validity of a requested financial transaction comprising the steps of: receiving data identifying means for carrying out the financial transaction; receiving data identifying a mobile network segment for routing communications to and from a mobile communication device associated with a user requesting the transaction; comparing the mobile network segment data and the data identifying the means for carrying out the financial transaction with a database of correlated data identifying one or more means for carrying out the or a financial transaction associated with further data identifying one or more mobile network segments; and determining the validity of the requested transaction in dependence on the result of the comparison. The transaction may be allowed if the transaction is determined to be authentic or declined if the transaction is determined not to be authentic.

According to another aspect of the present invention, there is provided apparatus for determining the validity of a requested financial transaction comprising: means for receiving data identifying means for carrying out the transaction; means for receiving data identifying a mobile network segment data for routing communications to and from a mobile communication device associated with a user requesting the transaction; means for comparing the network segment data and the data identifying the means for carrying out the transaction with a database of correlated data identifying one or more means for carrying out the or a transaction associated with further data identifying one or more mobile network segments; and means for determining the validity of the requested transaction in dependence on the result of the comparison. The apparatus may be arranged to allow the transaction if the transaction is determined to be authentic or decline the transaction if the transaction is determined not to be authentic.

Using the data identifying a means for carrying out a transaction, such as an ATM or PoS terminal, the system is able to distinguish one means for carrying out a transaction from another means from carrying out a transaction. Further, using the data identifying a particular mobile network segment also allows the system to distinguish one mobile network segment from another network segment. The identification data may be position-less or location-less identification data because the data does not need to comprise position or location information. In preferred embodiments, the means for carrying out or performing the transaction is an ATM or a PoS. Further, the transaction may be a financial transaction.

The data identifying the mobile network segment may be one or more of location area identifier data, routing area identifier data, cell identifier data. This has the advantage that the current mobile systems may be used without modification to the mobile system. The mobile network segment data is preferably numeric data such as 077835566 or an alpha-numeric code such as A0351 or B352.

The data identifying means for carrying out the transaction may comprise Automated Teller Machine identification data or Point of Sale identification data. Preferably, the identification data consists of data identifying a means for carrying out a transaction and data identifying a mobile network segment associated with the user requesting the transaction. That is to say that the identification data may only include data identifying a means for carrying out a transaction and data identifying a mobile network segment associated with the user requesting the transaction.

Preferably, the database of correlated data further comprises data identifying the number of previously authenticated transactions requested at each of the one or more means for carrying out the transaction. This has the advantage that a check against the number of previously authenticated transactions for a particular means for carrying out a transaction can be made, so that the transaction can be authenticated with more certainty. Preferably the data identifying the number of previously authenticated transactions is numeric data such as 1433, 3, 501, or 21.

The means for receiving data identifying a means for carrying out the transaction may be a wireless or wired network such as an Ethernet network or a WiFi® network. Alternatively it may be a cable or wire. The means for receiving data identifying a mobile network segment for routing communications via a mobile communication device associated with a user requesting the transaction may also be a wireless or wired network such as an Ethernet network or a WiFi® network. Alternatively it may be a cable or wire. The means for comparing the network segment data and the data identifying the means for carrying out the transaction may be a processor, server or chip which may be programmed to perform the method steps according to embodiments of the invention.

The database may be stored on a computer or server or may be directly stored on read only memory or rewritable random access memory or on other read only or rewritable media such as one or more hard discs, such as a hard disc with magnetic data storage.

The means for determining the number of previously authenticated transactions may be a computer or server or chip which when programmed perform method steps according to embodiments of the invention. Further, the means for updating the data identifying the number of previously authenticated transactions performed by the means for carrying out the transaction may be a computer or server or chip which when programmed perform method steps according to embodiments of the invention. Also the means for adding newly correlated data may be a computer or server or chip which when programmed perform method steps according to embodiments of the invention.

Embodiments of the invention may also be implemented both in computer software as well as directly in chips and the like directly integrated into a server. The software may be provided on a carrier medium such as a CD ROM (Compact Disc Read-Only Memory) or may be transmitted over a network.

Embodiments of the invention have the advantage that a user's privacy is maintained because only a comparison of mobile network segment identification data and data identifying means for carrying out a transaction is made. Furthermore, not determining the geographical location of the mobile communication device or the means for carrying out a transaction has advantages in terms of speed because calculation of the position of these devices is relatively time consuming. The present system is therefore able to operate more quickly operate with the authorisation process of a transaction such as an ATM withdrawal.

Furthermore, embodiments of the invention are much more cost effective because they do not use relatively expensive location techniques such as GPS to identify the location.

Finally, embodiments of the invention overcome the problem that the position of many ATM's or PoS's is not known, and so no comparison of the location of the ATM or PoS can be made with the location of a mobile telephone associated with a user requesting the transaction. Embodiments of the invention overcome this problem by comparing the mobile network segment data and the data identifying the means for carrying out the financial transaction with a database of correlated data identifying one or more means for carrying out the or a financial transaction associated with further data identifying one or more mobile network segments; and determine the validity of the requested transaction in dependence on the result of the comparison.

### BRIEF DESCRIPTION OF THE DRAWINGS

An embodiment of the invention will now be described in detail, by way of example only, with reference to the accompanying drawings in which:

FIG. 1 shows a schematic diagram of the system architecture of an embodiment of the invention;

FIG. 2 shows the main steps performed by an embodiment of the invention populating the database with transaction data;

FIG. 3 shows a physical representation of an ATM or PoS terminal correlated with mobile data;

FIG. 4 shows a modified form of the physical representation of FIG. 3 in which the location data has been removed;

FIG. 5 shows a representation of correlated data;

FIG. 6 shows the main steps performed by a further embodiment of the invention when a transaction is being authenticated; and

FIG. 7 is a schematic diagram shown the logical correlation key process.

### DETAILED DESCRIPTION OF PREFERRED EMBODIMENT

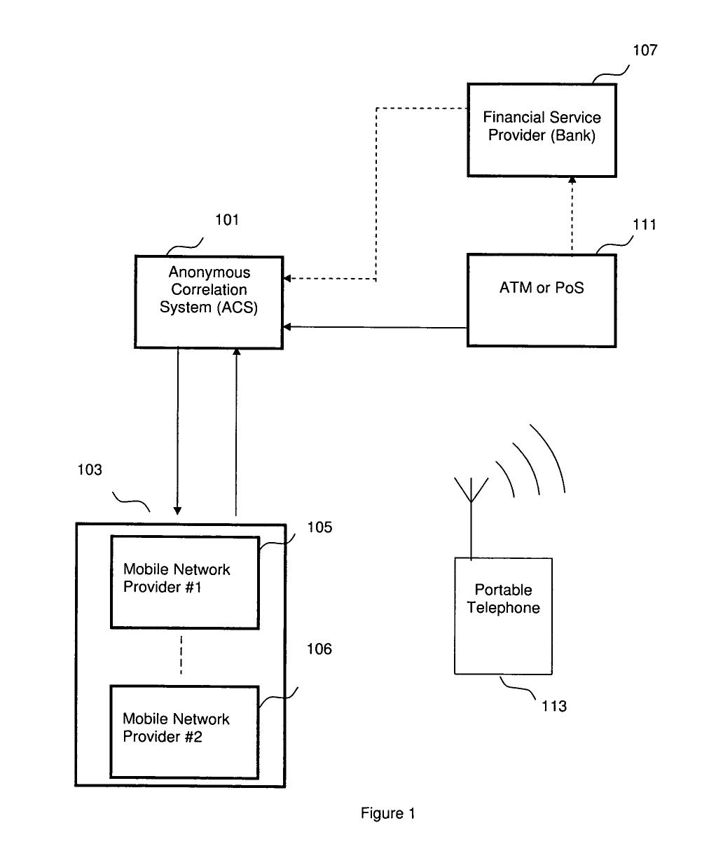

Referring to FIG. 1, a card-present security system comprises a server or computer 101, otherwise known as an anonymous correlation system (ACS). The server or computer 101 determines whether a transaction is likely to be fraudulent or not, as described in further detail below. The system may further comprise mobile networks, 105, 106, a mobile communication device 113, such as a portable telephone, a bank or financial service provider 107, an Automatic Teller Machine (ATM) or Point of Sale (PoS) 111 terminal. Information about the mobile networks may be provided by a single network data aggregator, 103, or may alternatively be provided directly by one or more mobile network providers, 105, 106.

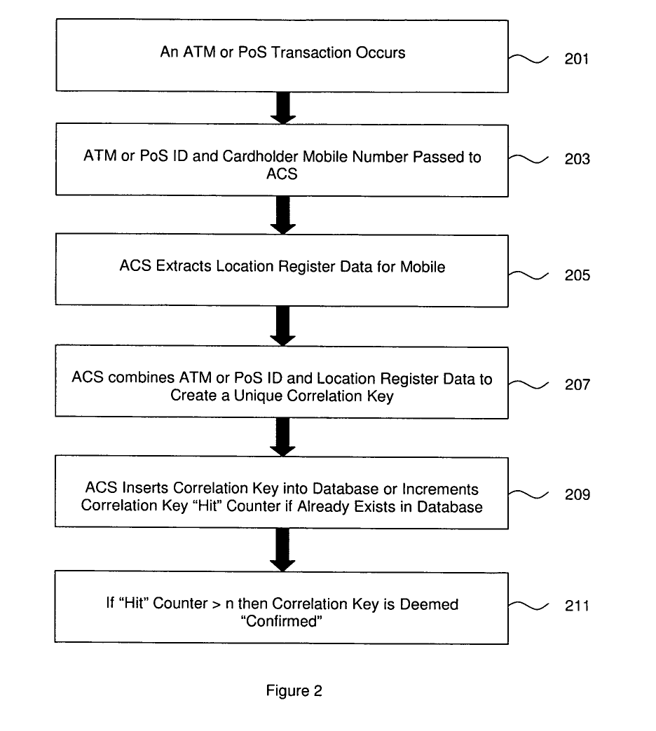

The main steps carried out by an embodiment of the invention will now be described. Referring to FIG. 2, this shows how a database of information is built up which subsequently allows the computer or server 101 to determine whether a transaction is likely to be fraudulent.

A user first starts a transaction at an ATM, PoS terminal, or at any other means for carrying out a financial transaction, at step 201. If the transaction is being executed at an ATM, the user inserts a card into the ATM and enters his PIN number. Alternatively, if the transaction is being carried out at a PoS terminal, then the user may physically pass the card to the retailer who inserts the card into a card reader for processing. The user may optionally enter a PIN, if the card is a chip and PIN card. Other verification schemes such as signature may also be used, alternatively or in addition to a PIN. In all cases, the card comprises data allowing the user's account to be identified. Usually this information is in the form of a sequence of numbers such as decimal numbers.

The ATM or PoS terminal then sends information or data identifying the ATM or PoS terminal to the financial service provider. The ATM or PoS ID is an identifier which allows each ATM or PoS terminal to be uniquely identified. The identifier may be a concatenated value comprising two or more fields. PoS terminals within a single store, for instance, may all have the same values. This does not affect the operation of the anonymous correlation system (ACS) as this does not require absolute uniqueness. The ATM or PoS terminal also sends to the financial service provider information or data identifying or associated with a user account with the financial service provider. Usually this data is the card holder's credit or debit card number or/and the card holder's name. The information may sent using conventional wired or wireless technology, for example, over a computer network and may be sent in an encrypted form.

The financial service provider receives the information or data identifying the means for carrying out the transaction as well as the information or data identifying or associated with a user account.

The financial service provider then searches a customer data base or look-up table for information identifying a mobile communication device which is associated with the user requesting the transaction.

The mobile communication device is usually a wireless mobile telephone which uses radio technology to communicate with other devices or computers via a network of base stations. However, personal digital assistants (PDA's) or other hand held computer devices may also be used. In the case of portable telephones, the information identifying the mobile communication device may be a telephone number, as shown in table 1.

TABLE 1
Part of a look-up table in an issuing bank.

| Card Holder Name | Card number | Telephone number |
|---|---|---|
| Mr A Smith | 5432 1234 5678 9998 | 00 44 7981 123 789 |
| Mr A Smith | 5432 1234 5678 9999 | 00 44 7981 123 789 |
| Mr N Jones | 5432 1234 0123 4567 | 00 44 7981 567 831 |

The financial service provider searches the look-up table using the card holder identifying information, for example the card number. The look-up table has card holder identifying information for each card holder and also information enabling the card holder's mobile communication device to be determined. The card holder identifying information for each user is associated with at least one piece of information identifying the card holder's communication device, such as a (unique) telephone number of the portable telephone associated with the user carrying out the transaction. Further, each card holder may have more than one entry in the look-up table because they may have more than one card with the financial service provider. These steps performed by the financial service provider are not essential, however, embodiments of the invention do require the financial service provider to send the information identifying the mobile communication device as well as the unique PoS terminal or ATM identifier to the server 101, at step 203. This information may be sent in an encrypted form.

Usually, a mobile communication device will be associated with a user carrying out a transaction. The device should also be registered with the financial service provider so that the financial service provider has information identifying the device, such as the telephone number in their database.

Furthermore, the server 101 may be located within the financial service provider's organisation. However preferred embodiments have a server 101 which is physically separate from the financial service provider, and the data identifying a user account, for example, is sent using wireless or conventional wire technology to the server, 101.

Using the determined data identifying a mobile communication device, the server 101 then extracts Location Register (LR) information or data such as Home Location Register (HLR) information or Visitor Location Register (VLR) information by performing a HLR or VLR lookup from a commercially available database, at step 205. An HLR and VLR database is held by every mobile network provider and comprises information on that provider's permanent and visiting subscribers. The VLR database contains information about mobile devices which have moved into the network coverage provided by a particular Base Transceiver Station (BTS) which is not part of the device's home network.

The HLR and VLR data comprises information about the location area, the routing area, the mobile switching centre (MSC), and the cell identifier of each mobile device being used. The mobile switching centre provides wireless communications which covers a geographical area that contains one or more Location Areas (LAs). Each LA contains one or more cells which means that each location area comprises one or more base stations which provide wireless radio coverage to different geographical areas within the location area.

Further, the MSC controls a number of the base stations and determines which base station the mobile device should use. Whenever the MSC is informed of a new mobile device on its network, the MSC updates the VLR database to include information about that mobile device, and also updates the HLR with the new location of the mobile device.

Each location area has a unique identifier assigned to it in order to identify a particular area. If the mobile device is a General Packet Radio Service (GPRS) enabled device, each location area is further subdivided into a number of routing areas, each of which is also assigned a unique identifying code. A cell identifier is also provided which allows a subset of the mobile devices within a particular location area to be identified, while the location area identifier allows a subset of the mobile devices within a particular MSC to be identified. In other words, the identifiers are hierarchical with the MSC identifier covering a larger geographical area than the location area, which in turn covers a larger geographical area than the cell identifier.

Usually, the HLR and VLR data, are stored in physically separate data stores. An example of typical HLR data for a particular mobile device is as follows:
“number=447980111111; mcc=234; mnc=10; location=447802000124; hcountry=United Kingdom; hnetwork=O2; ccountry=UK; cnetwork=BT (O2)”.

In this example, the MSC is the field marked “location”, and the mobile telephone number is the field marked “number”, while the fields “hcountry” and “hnetwork” define the home country and the home network respectively, and the fields “ccountry” and “cnetwork” define the current country and network of the mobile device respectively.

The VLR data takes a similar form; however, it holds more detailed information than the HLR data such as Location Area Identifier, Routing Area Identifier or Cell Identifier data. As each Location Area or/and Routing Area may comprise multiple cells, embodiments of the invention may only use the HLR data (MSC level data only) or may alternatively or additionally use VLR data such as the LA or/and RA or/and Cell identifier (Base Transceiver Station (BTS) identifier), depending on the granularity of data required.

These identifiers uniquely identify different parts of the mobile network. That is to say, information is available which allows identification of the current mobile network segment (i.e. MSC identifier, location area or routing area or cell identifier) which a mobile device is located in. In this way, mobile network operators provide a number of different network segments, such as MSCs in different locations in order to provide radio coverage, and hence a mobile communications network, in different geographical regions. Therefore mobile devices located in different locations will usually be routed via different mobile network segments such as MSCs.
An extract from the databases containing LR data such as HLR or VLR data is shown in tables 2 and 3.

TABLE 2
an extract of a database comprising HLR data.

| | HLR data |
|---|---|
| Telephone number | MSC Identifier |
| 00 44 7981 123 789 | 077835566 |
| 00 44 7981 567 831 | 083215651 |
| 00 44 7981 765 138 | 056756512 |

TABLE 3
an extract of a database comprising VLR data.

VLR data

| | | Cell (BTS) |
|---|---|---|
| Telephone number | Area ID | ID |
| 00 44 7981 123 789 | A0128 | B595 |
| 00 44 7981 567 831 | A0022 | B012 |
| 00 44 7981 765 138 | A0351 | B352 |

Embodiments of the invention use this information (which may be stored on a mobile network aggregator or may be stored by the mobile network providers) and extract the HLR or VLR data to populate an ACS database.

In order to extract the LR data, the aggregator 103, or mobile network provider may search the LR data for LR data which is associated with an identifier which matches or corresponds to the identifier of the mobile communication device of the user requesting the transaction. The aggregator 103, or mobile network provider may search the LR data using the data identifying the mobile communication device of the user requesting the transaction i.e. using a mobile telephone number. Although the server 101 does not usually perform this step of searching or extracting LR data, it can in principle perform this step provided it is provided with access to the LR data.

In the case of a Home Location Register (HLR) database, the server 101 looks up information identifying a particular network segment, such as a Mobile Switching Centre (MSC) or Location Area (LA) or Cell ID to which a mobile communication device (such as a mobile telephone) associated with a user carrying out the transaction is connected.

That is to say, the aggregator 103, or mobile network provider may search the LR data for a mobile network segment identifier which is associated with a field which corresponds to or matches the field used to search the LR data. For example, a location field may be used to search the LR data. Although the server 101 does not usually perform this step of searching the LR data, it can in principle perform this step provided it is provided with access to this data.

Although the identity of the network segment contained in the HLR or VLR database means that the mobile device is in the vicinity of that particular segment, embodiments of the invention do not require any information as to the actual physical location of where the financial transaction is occurring or of the location of the mobile communication device or of the location of the mobile network segment.

In one embodiment, the HLR or VLR database may be provided on an external server, known as a mobile network data aggregator, 103. It should be noted that the data stored on the computer or server or by the aggregator does not explicitly identify an actual location, such as a physical address or a Latitude/Longitude coordinate or GPS derived data. The server 101 does not use geo-location information of any sort, that is to say it does not require the actual location information of an ATM or PoS terminal; just a unique identifier.

If the HLR/VLR databases are stored on the aggregator 103, the server 101 performs the HLR lookup by opening one or more communication channel(s) to the mobile network data aggregator 103. The network data aggregator holds HLR and VLR information for mobile communication devices registered with a mobile network provider. The network data aggregator may also have HLR and VLR data of more than one mobile network service provider 105, 106. This has the advantage that it is not necessary to interrogate each service provider separately in order to obtain the HLR or VLR data of a mobile communication devices registered with different service providers.

In order to extract the LR data, the aggregator 103, or mobile network provider may search the LR data for LR data which is associated with an identifier of the mobile device which matches or corresponds to the identifier of the mobile communication device of the user requesting the transaction. The aggregator 103, or mobile network provider may search may search the LR data using the data identifying the mobile communication device of the user requesting the transaction i.e. using a mobile telephone number. Although the server 101 does not usually perform the step of searching or extracting the LR data, it can in principle perform this step provided it is provided with access to this data. The network data aggregator 103 or server 101 is able to extract at step 205 the network segment identifier (i.e. MSC or LA or RA or cell identifier) from the HLR or VLR data which corresponds to the information enabling the card holder's communication device to be determined (i.e. mobile telephone number), as shown in tables 2 and 3. That is to say, the aggregator 103, or mobile network provider may search the LR data, using for example a field such as a location field, for a mobile network segment identifier which is associated with a field which corresponds to or matches the field used to search the LR data. Although the server 101 does not usually perform this step of searching or extracting the LR data, it can in principle perform this step provided it is provided with access to this data.

Preferably, only 1 identifier is used, however, in the case of VLR data, it is possible to use both the LA identifier and the cell identifier. The network segment data i.e. the MSC identifier or/and Area ID or/and cell ID associated with the information identifying the mobile communication device, such as a telephone number, is then passed to the server 101.

At step 207, the server 101 associates or combines the data identifying means for carrying out a transaction, such as the unique ATM or PoS terminal ID with the network segment data such as the MSC Code, or Area ID or cell ID for the mobile device associated with the user. An example of how the data is associated is shown in table 4. This table is diagrammatic and embodiments of the invention only require 1 network segment identifier to be associated with a particular ATM or PoS terminal identifier.

TABLE 4
Part of a database in the computer or server embodying the invention.

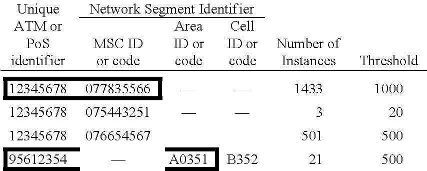

As the ATM and PoS networks are used in their normal everyday fashion the computer or server 101 records the ATM or PoS unique identifier and real-time network data of the mobile telephone associated with each transaction. This reference number does not, by itself, provide any information on geo-location of the telephone. The server 101 therefore associates unique ATM or PoS identifiers with network segment data, such as MSC ID or/and Area ID or/and cell ID, to create one or more correlation keys, as shown outlined in bold in table 4. Not all the correlation keys are outlined in bold in table 4 for the sake of clarity.

As the server 101 acquires more information about each ATM or PoS terminal it reaches a pre-defined threshold of certainty regarding that terminal and its association with each mobile network's corresponding HLR/VLR reference data. In one embodiment this may be the number of instances that a unique transaction identifier has been associated with a particular network segment identifier. Referring to table 4, the ATM or PoS identifier 12345678 shown in row 2, column 1 has been associated with a particular network segment identifier 077835566 shown in row 2, column 2 1433 times. This means that 1433 transactions have been carried out or attempted by users whose mobile communication device has the MSC code of 077835566 when the transaction was being attempted.

At this point the database shows a physical correlation between the HLR/VLR reference data and the physical ATM or PoS terminal, i.e. the ATM or PoS terminal is physically located within an anonymous area identified by those reference numbers.

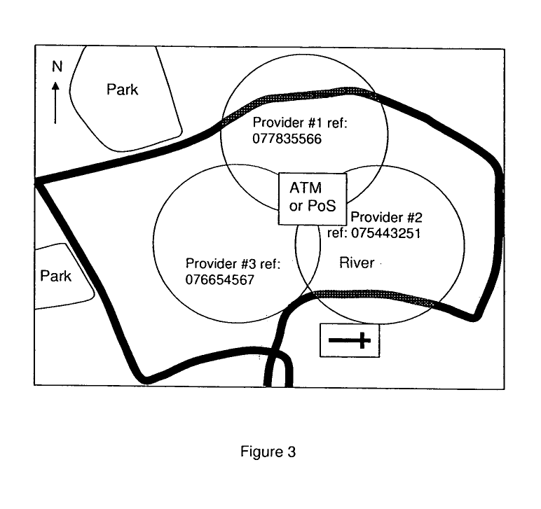

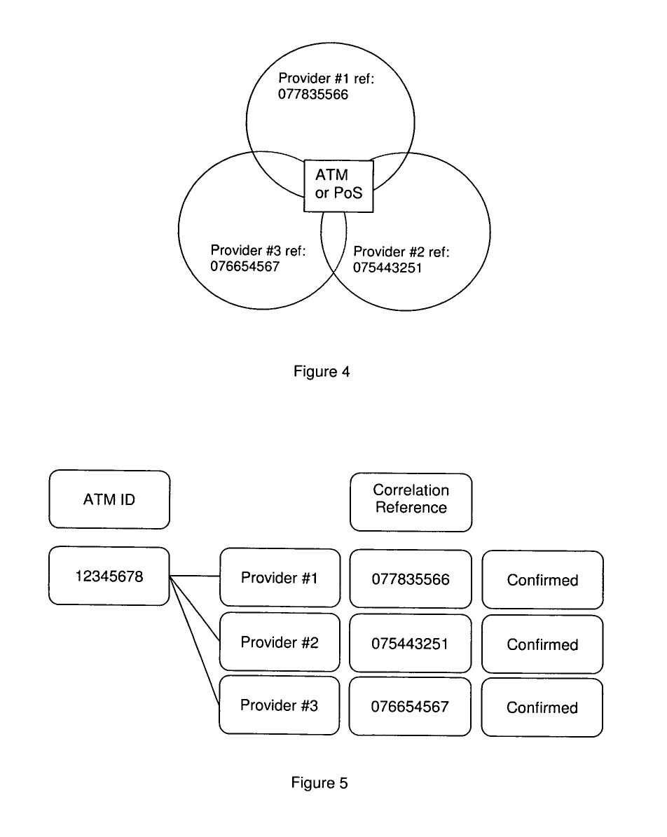

This is diagrammatically shown in FIGS. 3 and 4 of the drawings. FIG. 3 shows an example of a physical representation of the ATM/Network correlation. In a traditional location based system model the actual geo-location of the ATM or PoS terminal and areas covered by the network references are known. For example, it may be known that a particular ATM or PoS is located a certain distance north of a church or river, and a certain distance east of a park. Further the system may also know that the ATM or PoS is a certain distance from one or more roads, represented by thick black lines in FIG. 3. Further, the absolute location, i.e. longitude and latitued coordinates of the ATM or PoS shown in FIG. 3 may be known. FIG. 4 shows how embodiments of the invention represent the same information, with the geo-location of all entities being completely anonymous.

From FIG. 4, and table 4, it can be seen that three different mobile communication providers have the network segment identifier 077835566, 075443251, and 076654567 associated with the ATM (unique transaction identifier) 12345678.

In the first case, 1433 transactions have been attempted or carried out with the MSC code network segment identifier of 077835566. This means that is relatively certain that any future transaction carried out at the ATM with unique identifier 12345678 associated with network segment identifier 077835566 is likely to be valid because there have been over 1400 previous transactions or attempted transactions associated with both that unique transaction identifier and that network segment identifier.

Row 3 of table 4 shows that 3 transactions have been attempted or carried out at the same ATM or PoS terminal with identifier 12345678. This is physically shown in FIGS. 3 and 4 where it can be seen that there is a different MSC code, which is because these three transactions have been carried out by cardholders subscribing to a different mobile provider. In this case, 3 transactions have been carried out at an ATM or PoS terminal with the unique identifier of 12345678 which is associated with an MSC code of 075443251. In this case, the ACS is still in its learning mode for this combination of ATM or PoS terminal and MSC because the number of occurrences have yet to exceed the predefined threshold shown at row 3 column 6. In this case, the computer or server 101 will indicate that it has insufficient data to determine whether or not the transaction is likely to be fraudulent. In this case, the financial service provider may decide to allow this third transaction depending upon its own assessment of the likelihood of legitimacy of the transaction.

Row 4 of table 4 shows that 501 attempted transactions have been carried out at an ATM or PoS terminal with unique identifier 12345678. Once again, this is the same unique identifier as that shown in rows 2 and 3 of table 4, but with a different associated MSC code of 076654567. This also is because the transaction is being carried out by a user whose associated mobile communication device is connected to the mobile network using a different service provider than the previous examples shown in rows 2 and 3 of the table. This is also schematically shown in FIGS. 3 and 4. Because the number of transactions (501) that have been attempted with an ATM or PoS identifier of 12345678 which is associated with the MSC code of 076654567 exceed the predefined threshold (500), this means that any future transaction carried out at ATM or PoS with unique identifier 12345678 with a network segment identifier of 076654567 can be authenticated as likely to be genuine.

Finally, in row 5 of table 4, 21 previous transactions has been attempted at an ATM or PoS terminal with unique identifier of 95612354, not shown in FIG. 3 or 4, is associated with the network segment identifier of Area ID=A0351 or BTS=B352. Once again, table 4 is schematic because it is only in fact necessary to associate 1 network segment identifier, for example an Area ID or a Cell ID with the unique ATM or PoS identifier.

As transactions are attempted, each ATM or PoS identifier is associated with one or more network segment identifiers and the computer or server increments the number of instances of attempted transactions with corresponding or matching identifiers and network segment identifiers in column 5, at step 209, in order to build up a database of one or more correlation keys. If there is no corresponding or no matching correlation key in the database, the server 101 adds the new correlation key into the database.

The final column of table 4 shows a threshold value above which the server 101 determines the legitimacy or non-legitimacy of transactions carried out at that ATM or PoS terminal. Where the threshold value has not been exceeded the ACS is still in its learning mode for that ATM/PoS terminal and network.

Preferably, if the number of instances of attempted transactions is greater than a threshold value, n, then the correlation key is determined to be confirmed, at step 211.

An alternative representation of a database used by embodiments of the invention is shown in FIG. 5. Once again, this database shows the unique ATM or PoS identifier 12345678 which is associated with three different network segment identifiers 077835566, 075443251, 076654567 of three different provides of mobile communications forming three different correlation keys. An optional column showing details of the mobile communication service providers is included. A final column is also provided showing that the correlation key is confirmed, meaning that any future transaction attempted at the ATM or PoS with unique identifier 12345678 by a user who has an associated mobile communication device which has a current network segment identifier of either 077835566 or 075443251 or 076654567 is likely to be genuine, that is to say the number of instances of a particular transaction with ATM or PoS identifier associated with a particular network segment identifier is greater than the threshold value.

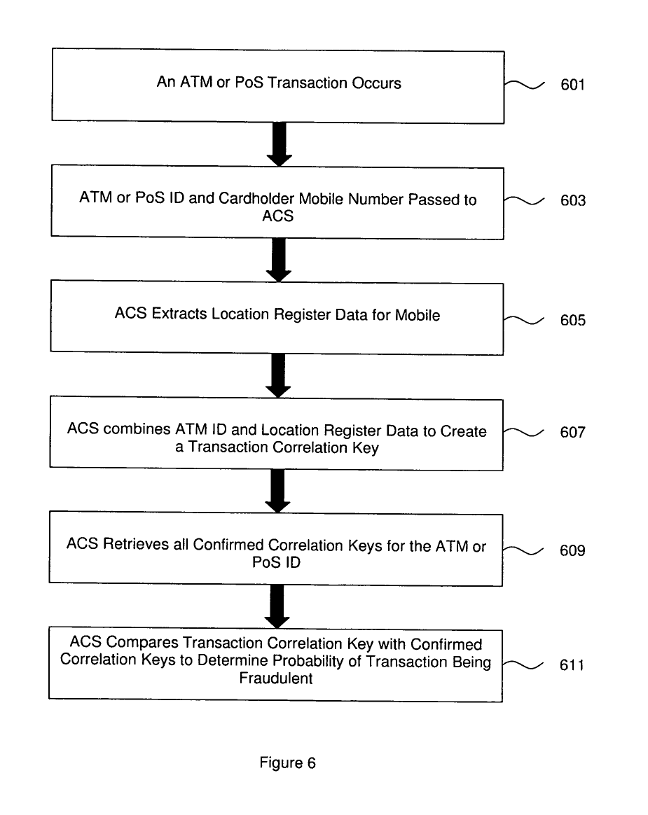

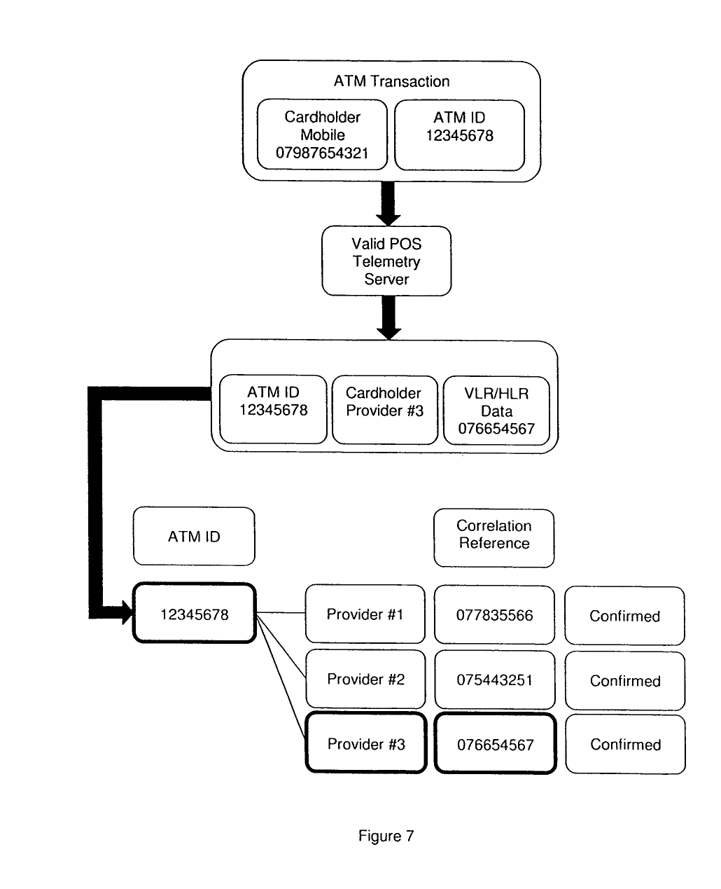

The authentication process carried out by embodiments of the invention will now be described with reference to the flow diagram of FIG. 6, and the schematic diagrams of FIGS. 1 and 7. At step 601, a user attempts an ATM or PoS transaction. As previously described conventional authentication using a PIN or/and signature is required. The ATM or PoS identifier and data identifying a user account, such as card number, is then passed to the server or computer 101.

As previously described, the computer or server 101 may include information enabling the telephone number of the mobile communication device associated with the user who is attempting the transaction to be determined. This may be in the form of the look-up table shown in table 1. However, it is preferable that a bank or other financial service provider provides this information to the server or computer 101. In both cases, the data identifying the means for carrying out a financial transaction, such as an ATM or PoS identifier as well as the data identifying a mobile communication device associated with a user requesting the transaction, such as a portable telephone number is passed to the server, 101, at step 603.

At step 605, the server or computer 101 extracts the HLR or VLR data associated with a particular mobile communication device by using one or more commercially available database(s), as previously described with reference to table 2. The system 101 combines the ATM or PoS identifier and the network segment identifier such as MSC ID or/and Area ID or/and cell ID to create a transaction correlation key, at step 607. The server or computer 101 then retrieves from the database, which may be visually represented as shown in FIG. 5, or as shown in table 4 all confirmed correlation keys associated with an ATM or PoS identifier corresponding to or matching that of the transaction being attempted, at step 609. Where the cardholder's real-time mobile network segment identifier information (shown in columns 2 to 4 of table 4), as determined by the computer or server 101 and the ATM or PoS identifier corresponds to or matches a confirmed correlation key for that ATM or PoS terminal, the computer or server 101 determines that the cardholder is in the physical vicinity of the transaction and therefore the transaction is likely to be legitimate, at step 611.

Where there is no correspondence or a mismatch of the determined ATM or PoS identifier and the network segment identifier such as MSC identifier with a confirmed correlation key the computer or server 101 determines that the cardholder is not in the physical vicinity of the transaction. This means that the transaction is more likely to be fraudulent. The computer or server 101 may still record this information in the database of information as shown in table 4, in case the network reference codes have changed. This forms part of the self-learning process of the system.

For example, referring to table 4, if a user is attempting to carry out a transaction at an ATM or PoS with an identifier of 12345678 and the mobile communication device associated with that user has a determined network segment identifier of 077835566 (the MSC Identifier or code), then the transaction is likely to be legitimate. This is because the database contains the ATM or PoS identifier 12345678 which is associated with the network segment identifier 077835566, and 1433 previous transactions with this combination of identifiers have previously been attempted or carried out so that this particular correlation key is confirmed because the number of instances is greater than the threshold value.

On the other hand, if the database only contains the network segment identifiers for the unique transaction identifier 12345678 as shown in table 4, and the user who is attempting the transaction has an associated mobile communication device with a network segment identifier (MSC code) code of 91235562 (which is not in the database) then the transaction is more likely to be fraudulent, because no previous transaction with that unique ATM or PoS identifier has been found in the database with that network segment identifier.

As previously mentioned, where the database does not have sufficient confirmed information about an ATM or PoS identifier and associated network segment identifier to make a decision, the computer or server 101 may not determine the likelihood of validity of the transaction. This is only temporary because of the volume of card-present transactions occurring per day. As previously described, attempted transactions populate the database shown in table 4 for each device; ATM or PoS.

To counter the potential issue of the mobile networks arbitrarily altering their reference codes, embodiments of the invention preferably apply currency checks for each confirmed correlation key, i.e. when was it last “hit”. Where a mismatch occurs for a terminal with a confirmed correlation key (potential fraud) the mismatch information is still recorded as the relevant mobile network may have changed codes. As previously described, this new key will not be confirmed, however, until a sufficient number of “hits”, which are not all the same cardholder, and must be different or unique cardholders, have been recorded for the new code. The previous code may then be retired once its currency has expired, as each transaction for the correlation key will update its timestamp. If the transaction was indeed fraudulent, the new correlation key will never achieve the required threshold to become confirmed.

Embodiments of the invention incorporate a self-populating, self-learning database containing information derived from mobile telephony networks' databases in conjunction with card-present device identifiers (ATMs and Point-of-Sale terminals). The system operates in real-time or near real-time whenever a card-present ATM or PoS transaction occurs involving a card issued by the implementing bank. The card-present financial transactions may be cross-border or intra-country. The ACS database information will contain unique correlation keys derived from the mobile networks.

It will be noted that embodiments of the invention do not contain information which explicitly identifies an actual location, such as a physical address or a Latitude/Longitude coordinate or GPS derived data. The system does not use geo-location information of any sort, that is to say it does not require the actual location information of an ATM; just an identifier.

1. A method for authenticating a transaction comprising the steps of:
receiving data identifying a means for carrying out the transaction;
receiving data identifying a mobile network segment for routing communications via a mobile communication device associated with a user requesting the transaction;
comparing the mobile network segment data and the data identifying the means for carrying out the transaction with a database of correlated data identifying one or more means for carrying out a transaction associated with further data identifying one or more mobile network segments; and
authenticating the transaction in dependence on the result of the comparison.

2. A method according to claim 1 in which the database of correlated data further comprises data representing the number of previously authenticated transactions requested at each of the one or more means for carrying out the transaction.

3. A method according to claim 2 in which the data identifying each means for carrying out the transaction is further associated with the data identifying the number of previously authenticated transactions performed by the means for carrying out the transaction.

4. A method according to claim 2 further comprising the step of determining the number of previously authenticated transactions performed by the means for carrying out the transaction.

5. A method according to claim 4 in which the step of determining the number of previously authenticated transactions is performed by searching the correlated data, using the received data identifying the means for carrying out the transaction, for the number of previously authenticated transactions associated with the data identifying the means for carrying out the transaction.

6. A method according to claim 5 in which the number of previously authenticated transaction is determined as the number of transactions which are associated with the data identifying the means for carrying out the transaction which corresponds to the received data identifying the means for carrying out the transaction.

7. A method according to claim 2 in which the transaction is only determined to be authentic if the number of previously authenticated transactions is greater than a predetermined value.

8. A method according to claim 2 further comprising the step of updating the data identifying the number of previously authenticated transactions performed by the means for carrying out the transaction.

9. A method according to claim 8 in which the updating step is only performed if the transaction has been determined to be authentic.

10. A method according to claim 1 in which the data identifying the number of previously authenticated transactions is numeric data.

11. A method according to claim 10 in which the step of updating the data comprises incrementing by one integer the data identifying the number of transactions previously authenticated at the means for carrying out the transaction.

12. A method according to claim 1 in which the received data consists of the data identifying a means for carrying out a transaction and the data identifying a mobile network segment associated with the user requesting the transaction.

13. A method according to claim 1 further comprising the step of searching the database of correlated data using the received data identifying the mobile network segment or the received data identifying the means for carrying out the transaction.

14. A method according to claim 1 in which the transaction is determined to be authentic if the database of correlated data comprises data corresponding to the received data identifying the means for carrying out the transaction associated with data corresponding to the received data identifying the mobile network segment for routing communications via the mobile communication device associated with the user requesting the transaction.

15. A method according to claim 1 further comprising the step of adding newly correlated data to the database of correlated data.

16. A method according to claim 15 in which the newly correlated data comprises data corresponding to the received data identifying the means for carrying out the transaction associated with data corresponding to the received data identifying the mobile network segment for routing communications via the mobile communication device associated with the user requesting the transaction.

17. A method according to claim 15 wherein the step of adding newly correlated data is only performed if it is determined that the database of correlated data does not comprise data corresponding to the received data identifying the means for carrying out the transaction associated with data corresponding to the received data identifying the mobile network segment for routing communications via the mobile communication device associated with the user requesting the transaction.

18. A method according to claim 1 in which the mobile network segment data is received from a mobile network aggregator storing mobile network segment data of a plurality of mobile devices, the devices preferably registered with different mobile service providers.

19. A method according to claim 1 further comprising the step of receiving data identifying a user account of a user requesting the transaction.

20. A method according to claim 19 further comprising the step of searching a second database of correlated data comprising data identifying a user account associated with data identifying the mobile communication device associated with the user account.

21. A method according to claim 20 in which the searching step is performed by searching the second database using the received data identifying a user account, in particular a user account number.

22. A method according to claim 21 in which the data identifying a mobile communication device of a user requesting the transaction is determined to be the data which is associated with the data identifying a user account which corresponds to the received data identifying the user account of the user requesting the transaction.

23. A method according to claim 1 further comprising the step of searching a third database of correlated data comprising data identifying a mobile communication device which is associated with data identifying a mobile network segment for routing communications via a mobile communication device.

24. A method according to claim 23 in which the data identifying a mobile network segment for routing communications via the mobile communication device associated with a user requesting the transaction is determined to be the data which is associated with the data identifying the mobile communication device which corresponds to the determined data identifying the mobile communication device.

25. A method according to claim 1 further comprising the step of searching a database of Location Register data for data which is associated with data identifying the mobile communication device associated with the user requesting the transaction.

26. A method according to claim 1 further comprising the step of searching a database of Location Register data for the mobile network segment identifier data which is associated with a field.

27. A method according to claim 1 wherein the database of correlated data further comprises data indicative of when a transaction was last requested at each of the means for carrying out the transaction.

28. A method according to claim 27 in which the data identifying each means for carrying out the transaction is further associated with the data indicative of when a transaction was last requested at each of the means for carrying out the transaction.

29. A method according to claim 27 further comprising the step of determining when a transaction was last requested at the means for carrying out the transaction.

30. A method according to claim 29 in which the step of determining when the transaction was last requested at the means for carrying out the transaction is performed by searching the correlated data, using the received data identifying the means for carrying out the transaction, for the data indicative of when a transaction was last requested which is associated with the data identifying the means for carrying out the transaction.

31. A method according to claim 30 in which the data indicative of when a transaction was last requested is determined as the data which is associated with the data identifying the means for carrying out the transaction which corresponds to the received data identifying the means for carrying out the transaction.

32. A method according to claim 27 further comprising the step of determining the period of time which has elapsed between the transaction being requested and the transaction previously requested at the means for carrying out the transaction.

33. A method according to claim 32 in which the transaction is only determined to be authentic if the determined period of time is less than a predetermined period of time.

34. Apparatus for authenticating a transaction comprising:
means for receiving data identifying a means for carrying out the financial transaction;
means for receiving data identifying a mobile network segment for routing communications via a mobile communication device associated with a user requesting the transaction;
means for comparing the network segment data and the data identifying the means for carrying out the transaction with a database of correlated data identifying one or more means for carrying out a transaction associated with further data identifying one or more mobile network segments; and
means for determining the authenticity of the transaction dependence on the result of the comparison.

35. Apparatus according to claim 34 in which the database of correlated data further comprises data identifying the number of previously authenticated transactions requested at each of the one or more means for carrying out the transaction.

36. Apparatus according to claim 35 in which the data identifying each means for carrying out the transaction is further associated with the data identifying the number of previously authenticated transactions performed by the means for carrying out the transaction.

37. Apparatus according to claim 35 further comprising means for determining the number of previously authenticated transactions performed by the means for carrying out the transaction.

38. Apparatus according to claim 37 in which the means for determining the number of previously authenticated transactions searches the correlated data, using the received data identifying the means for carrying out the transaction, for the number of previously authenticated transactions associated with the data identifying the means for carrying out the transaction.

39. Apparatus according to claim 38 in which the number of previously authenticated transaction is determined as the number of transactions which are associated with the data identifying the means for carrying out the transaction which corresponds to the received data identifying the means for carrying out the transaction.

40. Apparatus according to claim 34 in which the transaction is only determined to be authentic if the number of previously authenticated transactions is greater than a predetermined value.

41. Apparatus according to claim 35 further comprising means for updating the data identifying the number of previously authenticated transactions performed by the means for carrying out the transaction.

42. Apparatus according to claim 41 in which the updating means only updates the data identifying the number of previously authenticated transactions if the transaction is determined to be authentic.

43. Apparatus according to claim 35 in which the data identifying the number of previously authenticated transactions is numeric data.

44. Apparatus according to claim 41 in which the updating means updates by one integer the data identifying the number of transactions previously authenticated at the means for carrying out the transaction.

45. Apparatus according to claim 34 in which the received data consists of the data identifying a means for carrying out a transaction and the data identifying a mobile network segment associated with the user requesting the transaction.

46. Apparatus according to claim 34 in which the data comparison means searches the database of correlated data using the received data identifying the mobile network segment or the received data identifying the means for carrying out the transaction.

47. Apparatus according to claim 34 in which the transaction is determined to be authentic if the comparison means determines that database of correlated data comprises data corresponding to the received data identifying the means for carrying out the transaction associated with data corresponding to the received data identifying the mobile network segment for routing communications via the mobile communication device associated with the user requesting the transaction.

48. Apparatus according to claim 34 further comprising means for adding newly correlated data to the database of correlated data.

49. Apparatus according to claim 48 in which the newly correlated data comprises data corresponding to the received data identifying the means for carrying out the transaction associated with data corresponding to the received data identifying the mobile network segment for routing communications via the mobile communication device associated with the user requesting the transaction.

50. Apparatus according to claim 48 wherein the means for adding newly correlated data only adds newly correlated data if it is determined that the database of correlated data does not comprise data corresponding to the received data identifying the means for carrying out the transaction associated with data corresponding to the received data identifying the mobile network segment for routing communications via the mobile communication device associated with a user requesting the transaction.

51. Apparatus according to claim 34 further comprising a mobile network aggregator storing mobile network segment data of a plurality of mobile devices registered with different mobile service providers.

52. Apparatus according to claim 51 wherein the apparatus is arranged to receive the mobile network segment data from the mobile network aggregator.

53. Apparatus according to claim 34 further comprising means for searching a database of Location Register data for data which is associated with data identifying the mobile communication device associated with the user requesting the transaction.

54. Apparatus according to claim 34 further comprising means for searching a database of Location Register data for the mobile network segment identifier data which is associated with a field.

55. Apparatus according to claim 34 in which the database of correlated data further comprises data indicative of when a transaction was last requested at each of the means for carrying out the transaction.

56. Apparatus according to claim 34 in which the data identifying each means for carrying out the transaction is further associated with the data indicative of when a transaction was last requested at each of the means for carrying out the transaction.

57. Apparatus according to claim 34 further comprising means for determining when a transaction was last requested at the means for carrying out the transaction.

58. Apparatus according to claim 34 in which the step of determining when a transaction was last requested at the means for carrying out the transaction is performed by searching the correlated data, using the received data identifying the means for carrying out the transaction, for the data indicative of when a transaction was last requested which is associated with the data identifying the means for carrying out the transaction.

59. Apparatus according to claim 34 in which the data indicative of when a transaction was last requested is determined as the data which is associated with the data identifying the means for carrying out the transaction which corresponds to the received data identifying the means for carrying out the transaction.

60. Apparatus according to claim 34 further comprising means for determining the period of time which has elapsed between the transaction being requested and the transaction previously requested at the means for carrying out the transaction.

61. Apparatus according to claim 34 in which the transaction is only determined to be authentic if the determined period of time is less than a predetermined period of time.

62. A system for carrying out a transaction comprising:
means for carrying out the transaction;
a server for storing a database of correlated data identifying one or more means for carrying out a or the transaction associated with further data identifying one or more mobile network segments for routing communications via a mobile communication device associated with a user requesting the transaction, the server being arranged to receive data identifying the means for carrying out the transaction and to receive data identifying a mobile network segment for routing communications via the mobile communication device associated with the user requesting the transaction;
wherein the server compares the network segment data and the data identifying the means for carrying out the transaction with the database of correlated data and allows the transaction in dependence on the result of the comparison.

63. A system according to claim 62 further comprising a mobile communication device associated with the user requesting the transaction.

64. A system according to claim 62 in which the transaction is allowed if the transaction is determined to be authentic or declined if the transaction is determined not to be authentic.

65. A computer readable medium for storing code or a computer program which when executed performs the method of claim 1.

66. A security system or security device comprising the system of claim 62.

67. A security system or security device comprising the apparatus of claim 34.
